(19) United States
(12) Patent Application Publication
(10) Pub. No.: US 2010/0180505 A1
(43) Pub. Date: Jul. 22, 2010

(54) PIT COVER

(75) Inventors: John Peter Sordo, Sydney (AU); Michael Grantham White, Sydney (AU); Ulrich Ernst Trog, Sydney (AU)

Correspondence Address: PEARNE & GORDON LLP, 1801 EAST 9TH STREET, SUITE 1200, CLEVELAND, OH, 44114-3108, US

(73) Assignee: ACO POLYCRETE PTY LTD, Sydney, NS (AU)

(21) Appl. No.: 12/600,708

(22) PCT Filed: May 20, 2008
(86) PCT No.: PCT/AU08/00694

§ 371 Date: Nov. 18, 2009

(30) Foreign Application Priority Data
May 21, 2007 (AU) 2007902658

(51) Int. Cl. E06B 3/34; E06B 3/32; E05C 21/02; E06B 7/00

(52) U.S. Cl. 49/70; 49/463; 49/465; 49/381

(57) ABSTRACT

A cover for closing the service opening of a pit casing, the cover including an opening with a hatch and a first member coupled to the cover that is accessible though the opening in the cover when the hatch is not in a closed position, wherein when the cover is in a closed position to close the service opening the first member is in cooperative proximity with a second member coupled to the pit casing that at most protrudes only a portion of the span of the service opening, and when the cover is in the closed position and the hatch on the cover is opened from its closed position the first and second members, may be coupled together to resist the cover from being moved to open the service opening.

### FIELD OF THE INVENTION

The present invention relates to a cover for a pit that contains services such as but not limited to power, data or communications cables or equipment, water or gas pipes or equipment, or drainage lines.

### PRIOR ART

It is to be noted that a reference to prior art herein is not an admission that the prior art is common general knowledge to a person skilled in the art or any other person in any sense whatsoever.

Service pits such as electrical pits containing power and data communications cables and equipment, water and gas pipes and equipment, and drainage pits provide a source of vulnerability to the security of the services and equipment in the pits which can be damaged, destroyed or otherwise disrupted by unauthorised access.

Furthermore service and drainage pits also can provide a source of vulnerability to the security of persons coming near the pit as the pit can be used as a concealed hiding place for explosives and other devices which are intended to inflict harm on such persons.

Therefore security against unauthorised access of service and drainage pits in security sensitive locations and applications is one important aspect of wider security strategy in securing the location, or the services and equipment in the pits.

One known solution of securing a service pit against unauthorised access is to provide the pit with a longitudinal cross bar that spans the service opening of the pit and a removable pit cover that can be locked into a closed position with a keyed padlock to the cross bar when the pit cover is in the closed position. In this prior art arrangement the cover is provided with an opening to provide access to the padlock when it locked to the pit cross bar and cover so the padlock is operable and removable from outside of the closed pit while the cross bar is enclosed in the closed pit, by the pit cover.

A disadvantage with this prior art is that when access to the service pit is required and the cover is removed from the service opening the longitudinal cross bar that spans the service opening of the pit obstructs the service opening and access to the pit.

One solution to this problem offered in the prior art is to make the longitudinal cross bar that spans the service opening of the pit removable after the pit cover is removed, for example by making the cross bar captive-ly engage-able with mating catches on the inside of the pit walls it spans.

In this way when access to the service pit is required and the cover is removed and the obstruction to the service opening by the cross bar is inconvenient for the access that is required then the cross bar and the obstruction it presents is removed. When access to the pit is no longer required, the longitudinal cross bar is repositioned in it's operable place and then the pit is closed by locking its cover to the cross bar.

A disadvantage in the removable cross bar embodiment of the prior art is that additional effort is required to provide unobstructed access to the service opening to remove the cross bar. An additional disadvantage in the removable cross bar embodiment of the prior art is that during prolonged periods when the cross bar is removed for access, the risk and prospects that the separated cross bar is misplaced, lost or damaged is increased.

It is an object of the invention to overcome some of the problems of the prior art or at least provide a useful alternative.

### SUMMARY OF THE INVENTION

A preferred embodiment of the invention provides a cover for closing the service opening of a pit casing, the cover including an opening with a hatch and a first member coupled to the cover that is accessible though the opening in the cover when the hatch is not in a closed position, wherein when the cover is in a closed position to close the service opening the first member is in cooperative proximity with a second member coupled to the pit casing that at most protrudes only a portion of the span of the service opening, and when the cover is in the closed position and the hatch on the cover is opened from its closed position the first and second members may be coupled together to resist the cover from being moved to open the service opening.

Preferably the hatch is biased in the closed position where it closes the opening in the cover.

Preferably the hatch can be latched in an open position where the opening in the cover is left uncovered.

Preferably the hatch is pivotally coupled to the cover.

Preferably the second member release-ably engages the hatch when the cover and hatch are in their respective closed positions and close their respective openings, and while the second member is in engagement with the hatch it resists opening of the cover and hatch from their respective closed positions.

Preferably the first member includes a cooperative opening through which the threaded portion of a bolt can extend and threading-ly engage a cooperative threaded aperture portion on the second member to couple the first and second member together, wherein the head of the bolt can be operationally accessed through the opening in the cover when the hatch is not in the closed position and when the bolt is operationally tightened to firmly couple the first and second members together it resists opening of the cover from its closed position.

Preferably the first member includes an opening though which a staple portion of the second member can extend when the cover is in the closed position, the staple portion including a hole formation that can receive the shank of a padlock, and when the cover is in the closed position and the shank of the padlock is received by the hole formation the padlock release-ably and lock-ingly can couple the first and second members together, wherein the padlock can be operationally accessed through the opening in the cover when the hatch is not in the closed position and locked or removed as required through the opening.

Preferably the first member includes an enclosure portion, the inside of the enclosure portion being in communication with the opening in the cover.

Preferably the second member is formed separately from and fixed to the pit casing.

Preferably the cover is release-ably hinge-idly coupled to the pit casing.

Preferably the cover and pit casing include hinge formations and corresponding hinge recesses or apertures arrangements and combinations to allow the cover to be release-ably hinge-idly coupled to the pit casing.

Preferably the pit casing includes a cover casing having two opposed openings wherein both opposed openings are in communication with the service opening of the pit casing and when the cover is in the closed position the two opposed openings are closed by the cover.

### DRAWINGS

The invention will now be described by way of example only with reference to the following drawings in which:

FIG. 1: illustrates a perspective view of a preferred embodiment of the invention where the cover is shown separated from the pit casing, and the hatch on the cover is shown in an open position;

FIG. 2: illustrates a portion of the embodiment in FIG. 1 in a partially exploded view;

FIG. 3: illustrates a side view of the embodiment in FIG. 1;

FIG. 4: illustrates the view in FIG. 3 with some hidden detail;

FIG. 5: illustrates the preferred embodiment in FIG. 4, with the cover shown in a partly open position relative to the pit casing, and the hatch in the cover in an open position;

FIG. 6: illustrates the preferred embodiment in FIG. 4, with the cover shown in a closed position relative to the pit casing;

FIG. 7: illustrates the pit casing in FIG. 4 that includes a cover casing, shown in exploded view;

FIG. 8: illustrates several views of the first member portion of the cover illustrated in FIG. 2;

FIG. 9: illustrates several views of an alternative embodiment of the second member portion to that illustrated in FIG. 2, that is fixed to the pit casing;

FIGS. 10a, 10b: illustrate the disposition of the first and second members illustrated in FIGS. 8 and 9, before and after the two are brought together in close proximity so they may be coupled together;

FIG. 10c: illustrates the coupling of the first and second members illustrated in FIG. 10b together by a padlock;

FIGS. 10d, 10e: illustrate the coupling of the first and second members illustrated in FIG. 10b together by a threaded bolt, shown before and after the bolt is located in situ;

FIGS. 11a to 11c: illustrate the hatch in the cover illustrated in FIGS. 1 and 2 in different operational positions relative to the embodiment of the first and second members illustrated in FIG. 10b;

FIG. 12: illustrates in schematic and in partially exploded perspective a preferred embodiment of the invention (pit casing not shown) used in combination with a second cover portion, where the hatch in the cover is shown in partially open position;

FIG. 13: illustrates the two cover portions and the cross bar shown in FIG. 12 interlocked when they are in situ and the covers are in a closed position;

FIGS. 14a to 14c: illustrate the coupling portion of the hatch illustrated in FIGS. 11a to 11c when the hatch is in different operational positions;

FIG. 15: illustrates the coupling portion of the hatch illustrated in FIGS. 11a to 11c in exploded perspective;

FIG. 16: illustrates coupling portion illustrated in FIG. 15 in assembled perspective.

### DETAILED DESCRIPTION OF EMBODIMENTS OF THE INVENTION

It is to be noted where possible features common to the various embodiments illustrated in the drawings are referred to in each drawing by a respective common feature number.

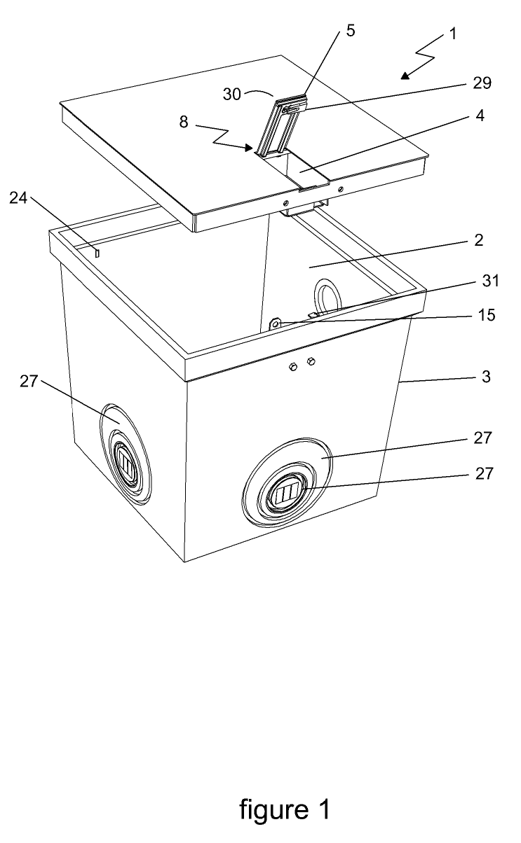

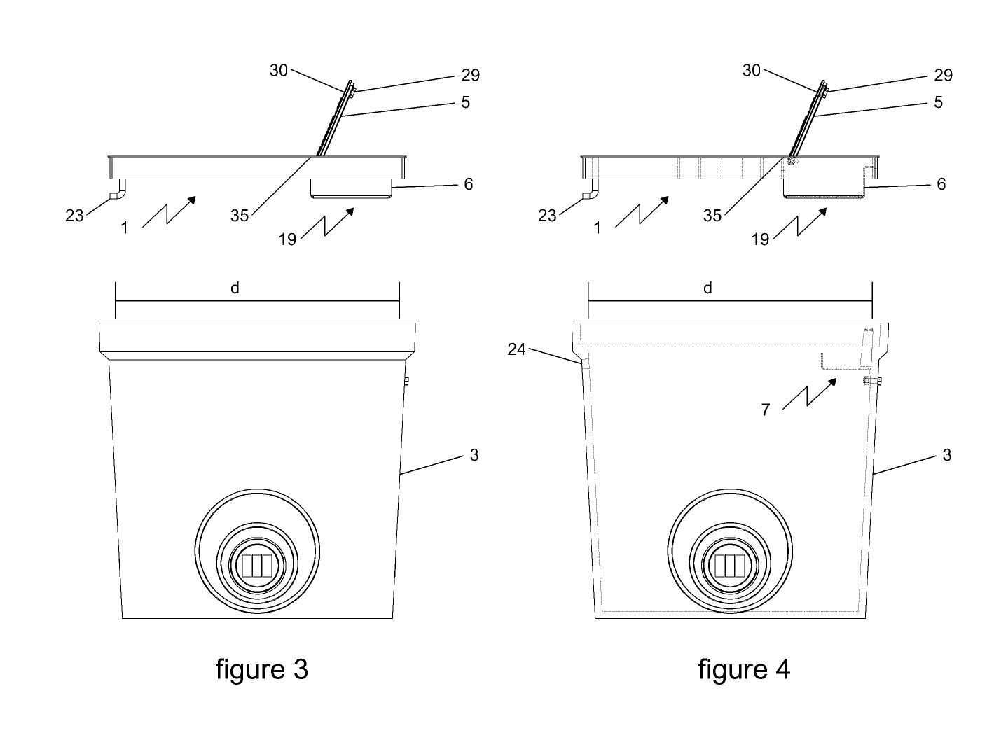

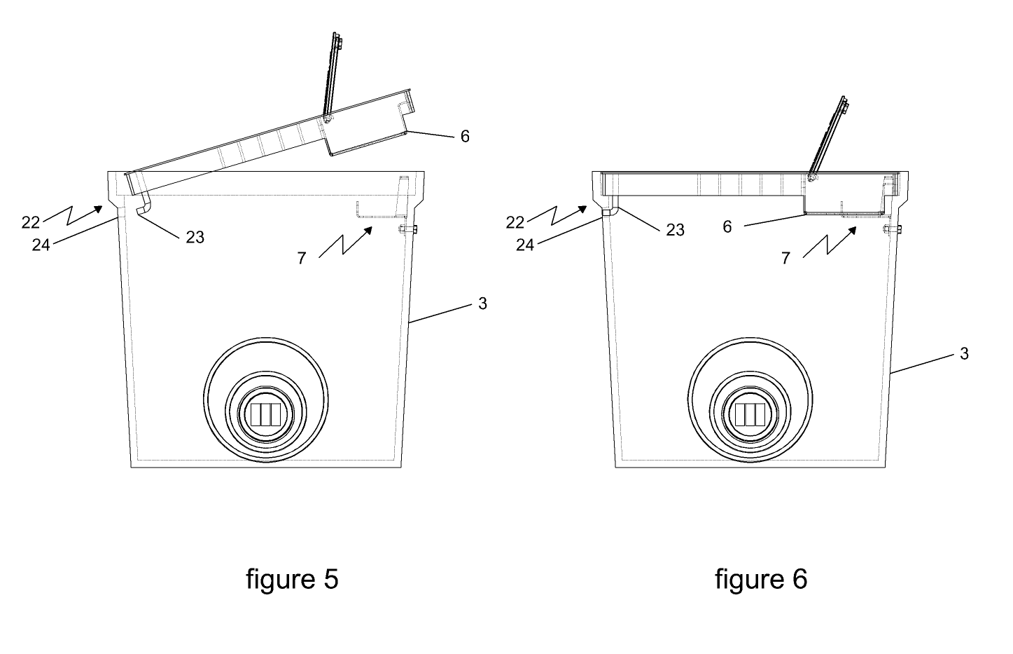

A first preferred embodiment of cover (1) for closing service opening (2) of a pit casing (3) in accordance with the invention is generally illustrated in FIGS. 1 to 6.

Pit casing (3) is an open container fabricated from a suitable material including but not limited to plastic, metal, pre-cast or in situ concrete, or polymer concrete, and may include pre-formed service knockouts (27).

Cover (1) includes opening (4) with hatch (5) and first member (6) coupled to cover (1) that is accessible though opening (4) in cover (1) when hatch (5) is not in a closed position.

Cover (1) includes hinge formations (23) for release-ably engaging corresponding hinge recesses or apertures (24) in casing (3) to allow cover (1) to be hinge-idly coupled (22) to pit casing (3).

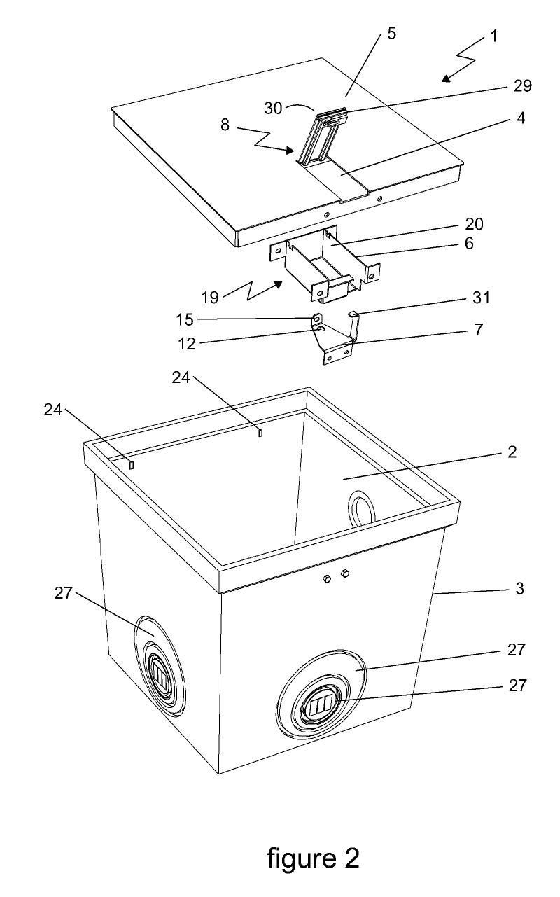

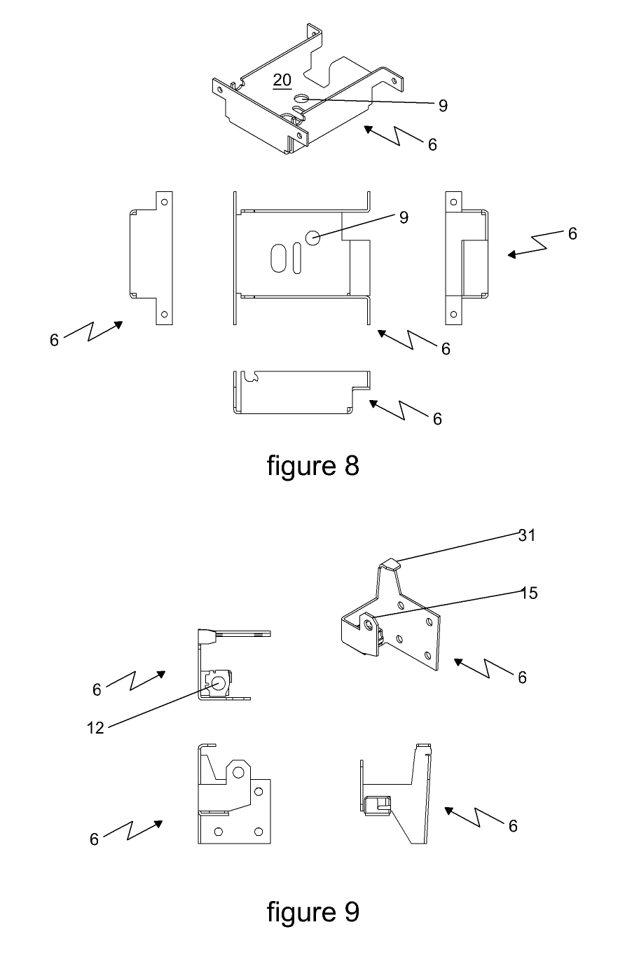

First member (6) includes an enclosure portion (19) as shown in FIGS. 2 to 6, 8, 10a to 10e that is fixed to the underside of cover (1) under opening (4) by some suitable means such as with fasteners (not shown), or fixed by a welding process (not shown) when cover (1) and first member (6) are made of metal, wherein the inside (20) of enclosure portion (19) is in communication with opening (4) in the cover (1).

Alternatively first member (6) may be an enclosure integrally formed on the underside of cover (1) such as by a suitable casting or moulding process wherein the inside (20) of enclosure portion (19) is in communication with opening (4) in the cover (1).

Casing (3) includes second member (7) that engage-idly co-operates with first member (6) to establish a means of coupling the two together.

Preferably second member (7) is formed separately from and fixed to pit casing (3) and includes a staple portion (15) that cooperatively engages first member (6) wherein second member (7) advantageously at most protrudes only a portion of span (d) of service opening (2) as shown in FIG. 4.

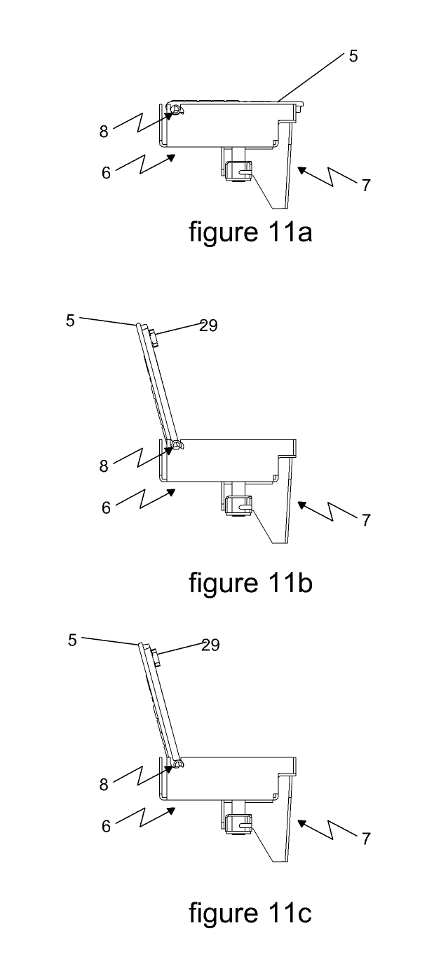

Hatch (5) is coupled to cover (1) by pivotal coupling (8) and can be hinge-idly operated between a closed position as shown in FIG. 11a where opening (4) in cover (1) is closed off and access to first member (6) through opening (4) in cover (1) is prevented while hatch (5) remains in this position, and an open position as shown in FIGS. 1 to 6, 11b where opening (4) in cover (1) is uncovered and first member (6) is accessible though opening (4) in cover (1).

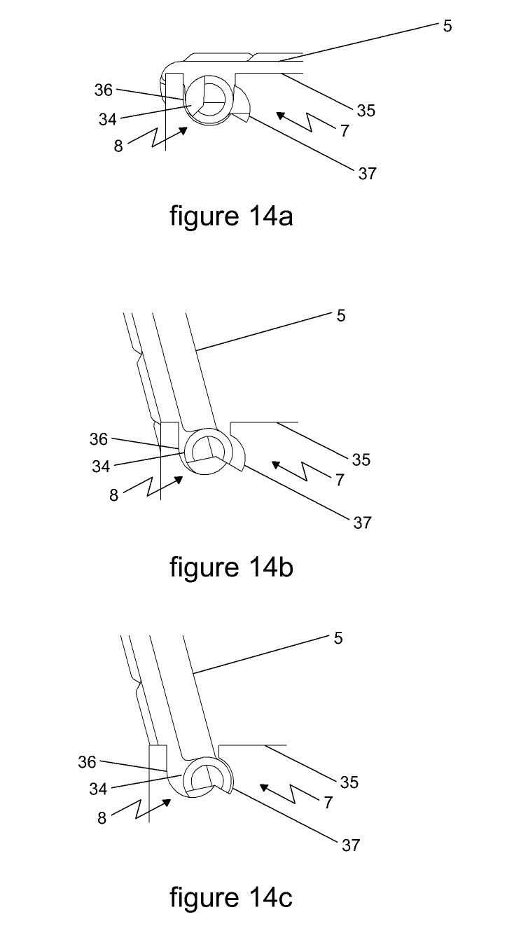

Pivotal coupling (8) as can be seen in FIGS. 14a, 14b, 14c, 15, 16 includes a recess (37) in hinge formation (36) on first member (6) that cooperates with hinge formation (34) on hatch (5).

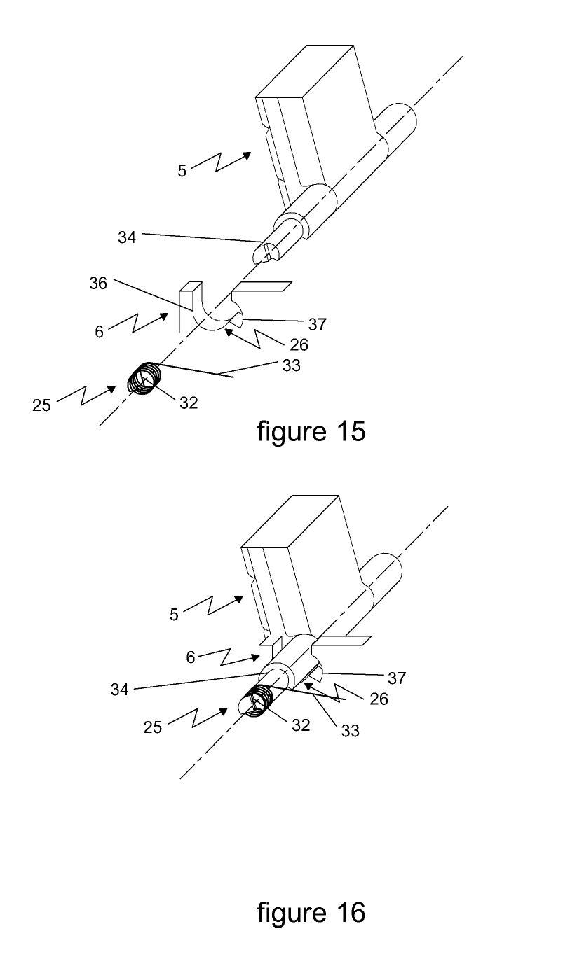

Hatch (5) preferably is biased in the closed position with a return spring (25) shown in FIGS. 15 and 16, to mitigate against hatch (5) being accidentally left open when not required to be left open and presenting a potential hazard to pedestrians and the like, and to mitigate against the ingress of undesirable foreign matter and debris into first member (6).

One end (32) of return spring (25) engages hinge formation (34) on hatch (5) as can be seen in FIGS. 15 and 16 and the other end (33) of return spring (25) abuts against (not shown) an underside (35) of cover (1), so as hatch (5) is moved from its closed position shown in FIG. 14a it is being moved against the bias of return spring (25) and when hatch (5) is released from any opening force it will be biased back to its closed position.

Pivotal coupling (8) on hatch (5) preferably is also configured as shown in FIGS. 14a, 14b, 14c, 15, 16 so that hatch (5) can be latched in an open position as shown in FIG. 11c, 14c by the operator (not shown) moving the hinged formation (34) of hatch (5) into a catch (26) which keeps hatch (5) in the open position against the bias of return spring (25).

Catch (26) as can be seen in FIGS. 14a, 14b, 14c, 15, 16 includes a recess (37) in hinge formation (36) on first member (6) which can engage cooperatively shaped hinge formation (34) on hatch (5) and prevent pivotal movement of hatch (5) relative to catch (26) and cover (1).

When hatch (5) is required to be released from the latched open position hinged formation (34) on hatch (5) is removed from catch (26) allowing pivotal movement of hatch (5) relative to catch (26) and cover (1) wherein return spring (25) biases and moves hatch (5) into the closed position.

Preferably second member (7) includes a latch portion (31) that cooperatively release-ably engages (not shown) hatch (5) when cover (1) and hatch (5) are in their respective closed positions.

Hatch (5) includes a sliding tab portion (29) that is operable from the outer side (30) of hatch (5) and can be moved between two operable positions (not shown), one position being a hatch operable position where tab portion (29) is not in latched engagement with latch portion (31) and the other being hatch locked position where tab portion (29) is in latched engagement with latch portion (31).

Preferably sliding tab portion (29) includes a biasing means (not shown) that biases sliding tab portion (29) in the hatch locked position.

Advantageously while latch portion (31) is in latched engagement with hatch (5) it resists the opening of cover (1) and hatch (5) from their respective closed positions.

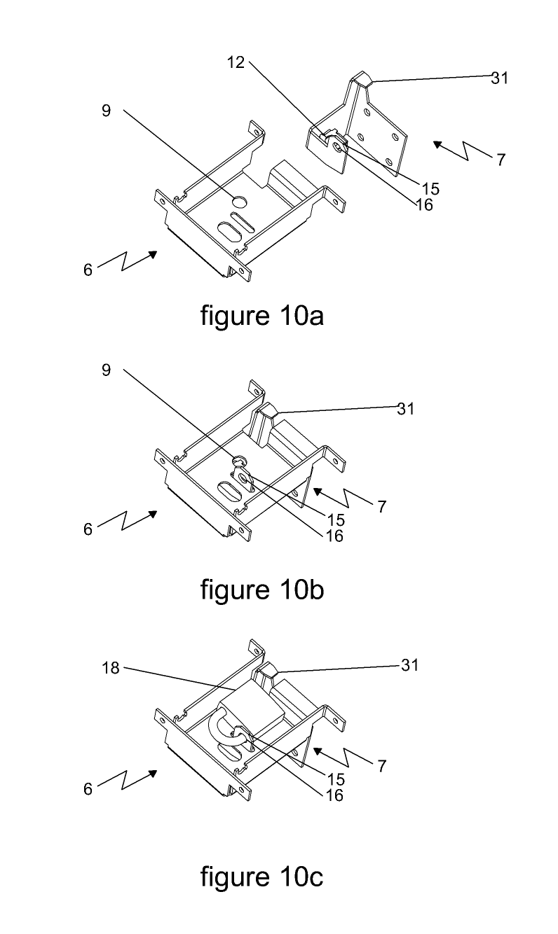

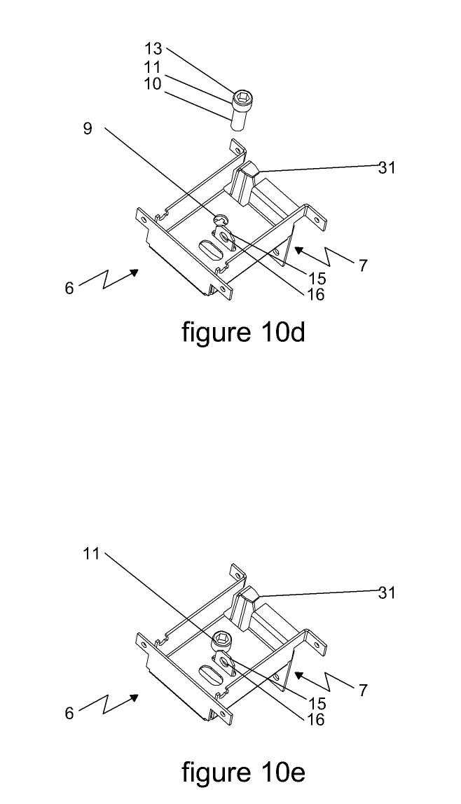

When cover (1) is in a closed position and closes service opening (2) as illustrated in FIG. 6 first member (6) and second member (7) are located in cooperative engagement proximity with each other as can be seen in FIGS. 6 and 10b.

When cover (1) is in a closed position and hatch (5) is in is the open position as shown in FIGS. 6, 10b, first member (6) and second member (7) may be coupled together by suitable means to mitigate against cover (1) being moved from its closed position to open service opening (2).

The means of coupling first member (6) and second member (7) together that is employed is contingent on the level of security that is desired in preventing unauthorised opening of cover (1).

For example FIGS. 10c and 10e illustrate two different methods of coupling first member (6) and second member (7) together.

In the embodiment illustrated in FIG. 10e first member (6) includes a cooperative opening (9) as can be seen in FIGS. 10a, 10b, 10d through which threaded portion (10) of bolt (11) can extend and thread-ingly engage a cooperative threaded aperture portion (12) on second member (7) as can be seen in FIGS. 9, 10a to couple the first and second member (7) together as can be seen in FIG. 10e.

In use head (13) of bolt (11) can be operationally accessed through opening (4) in cover (1) when hatch (5) is in the open position and when bolt (11) is operationally tightened to firmly couple the first member (6) and second member (7) together it resists opening of cover (1) from its closed position.

Preferably head (13) of bolt (11) is uniquely keyed (not shown) to receive a corresponding keyed release tool (not shown) that allows bolt (11) to be tightened or removed as required while remaining uncooperative with other release tools that are not correspondingly keyed. For example the release tool maybe an L shaped lever that is uniquely cooperatively keyed to a corresponding keyed socket in head (13).

In the embodiment illustrated in FIG. 10c first member (6) includes an opening (4) as can be seen in FIG. 10a though which staple portion (15) of second member (7) can extend when cover (1) is in the closed position and the first member and second member are located in cooperative engagement proximity with each other as can be seen in 10b.

Staple portion (15) includes hole formation (16) that can receive shank (17) of padlock (18), and when cover (1) is in the closed position and shank (17) of the padlock (18) is received by hole formation (16) padlock (18) release-ably and lock-ingly couples the first member (6) and second member (7) together, wherein padlock (18) is operationally accessed, locked or removed as required through opening (4) in cover (1) when hatch (5) is not in the closed position.

Advantageously when cover (1) and hatch (5) are in their respective closed positions and latch portion (31) is engaged with hatch (5) when the tab portion (29) in the hatch locked position, then a preliminary level of secured access to the contents of the pit casing is achieved as cover (1) and hatch (5) are engaged with second member (7) resisting the opening of cover (1) and hatch (5) from their respective closed positions.

Only when tab portion (29) is moved to the hatch operable position, hatch (5) is unlatched from second member (7) allowing at least hatch (5) to be moved form it's closed position allowing access to the first member (6) which advantageously may include an additional level of secured access to the contents of the pit casing as first member (6) may also be coupled to the second member (7) resisting the opening of cover (1) from its closed position while first member (6) and second member (7) remain coupled.

If the coupling between first member (6) and second member (7) is locked then this advantageously provides a further level of secured access to the contents of the pit casing.

When cover (1) is removed from covering service opening (2) of casing (3) and as second member (7) only protrudes a portion of the span (d) of service opening (2) advantageously it does not obstruct the complete span (d) when accessing the contents of pit casing (3).

In another embodiment (not shown) second member (7) may be a recess (not shown) in pit casing (3) so it does not protrude at all along span (d) of service opening (2).

In this embodiment first member (6) includes a lockable slide bolt (not shown) that can receive a padlock and can sliding-ingly engage the recess in pit casing (3) when cover (1) is in the closed position and the first member (6) and second member (7) are located in cooperative engagement proximity with each other.

In use when cover (1) is in the closed position the slide bolt can be operational accessed and operated to engage the recess in pit casing, and locked or released in that position by applying or releasing the padlock from the slide bolt as required through opening (4) in cover (1) when hatch (5) is not in the dosed position.

In this embodiment when cover (1) is removed from covering the service opening of casing (3) and as second member (7) is merely a recess in pit casing (3) and does not protrude at all along span (d) of service opening (2), then second member advantageously does not obstruct access to service opening (2) allowing free working access to the contents of pit casing (3).

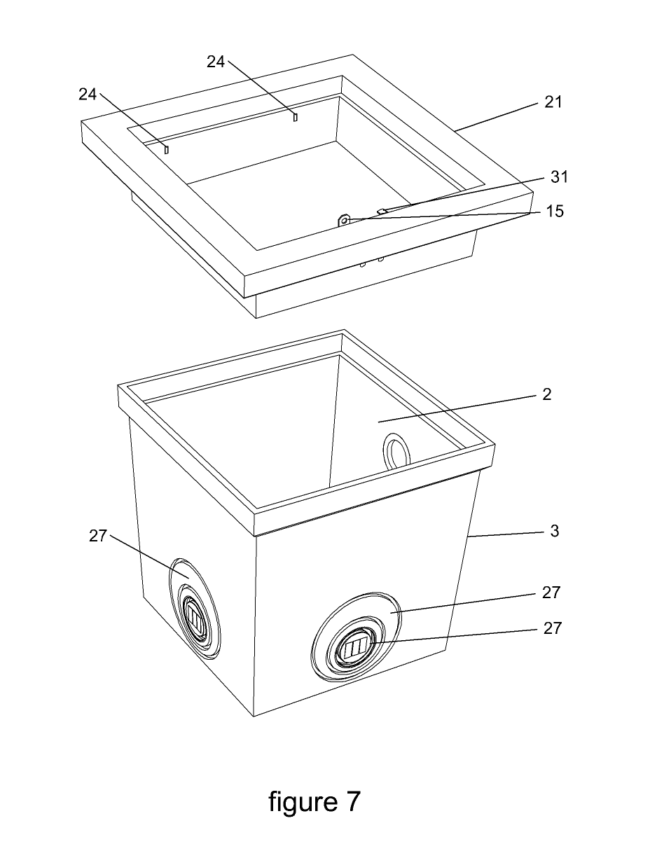

In another embodiment pit casing (3) may include a collar (21) as illustrated in FIG. 7 where collar (21) is a plinth that is fixed to pit casing (3) at service opening (2) providing structural reinforcement of service opening (2) in pit casing (3).

Collar (21) is cooperatively sized and shaped to interpose between pit casing (3) and cover (1), and cooperatively sized and shaped to receive cover (1) in an analogous way that casing (3) receives cover (1) in the embodiment illustrated in FIGS. 1 to 6.

In the collar (21) embodiment illustrated in FIG. 7, second member (7) is fixed to or formed on collar (21) in analogous way that it would be fixed to or formed on casing (3) in the embodiment illustrated in FIGS. 1 to 6.

Similarly collar (21) includes recesses or apertures (24) in analogous way that casing (3) includes recesses or apertures (24) in the embodiment illustrated in FIGS. 1 to 6 to receive hinge formations (23) on cover (1) to allow cover (1) to be release-ably hinge-idly coupled (22) to collar (21) in analogous way that it is release-ably hinge-idly coupled (22) to casing (3) in the embodiment illustrated in FIGS. 1 to 6.

Collar (21) may be fabricated from any suitable material including but not limited to plastic, metal, concrete, or polymer based concrete, and may be fitted to pits already installed in situ as a retrofit fitting.

In use cover (1) (not shown) closes off service opening (2) in the embodiment illustrated in FIG. 7 by closing off the collar opening (28).

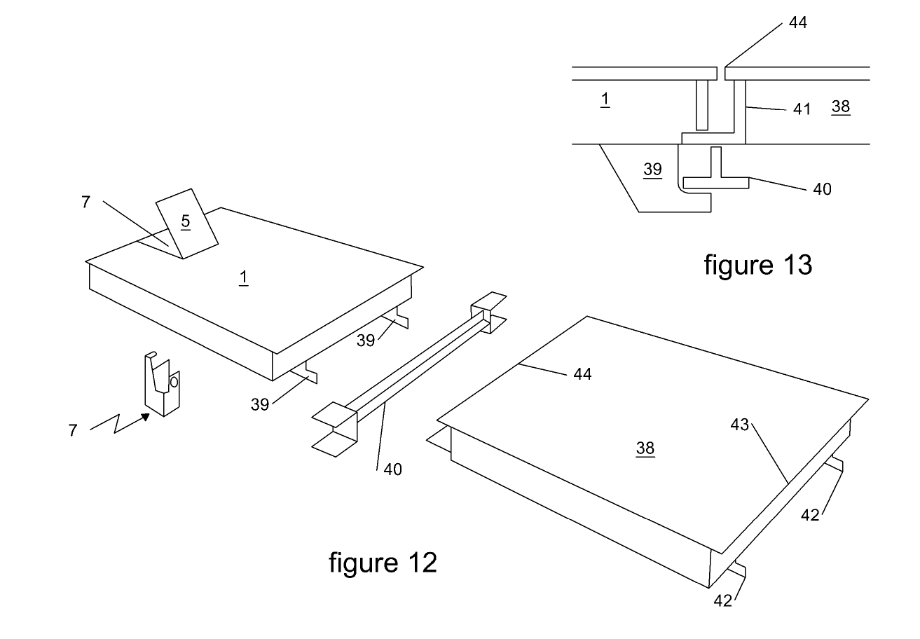

In another embodiment illustrated in FIGS. 12 and 13 cover (1) may be used as a part of a two part cover arrangement to for closing service opening of a pit casing (not shown). This embodiment is particularly useful for cases where smaller covers are desired for handling purposes.

Cover (1) includes opening (4) with hatch (5) and first member (not shown) coupled to cover (1) that is accessible though opening (4) in cover (1) when hatch (5) is not in a closed position similar to the embodiment illustrated in FIGS. 1 and 2, except cover (1) in the two part cover arrangement shown in FIGS. 12 and 13 include hinge formations (39) that engage a removable cross bar (40) that is coupled to the pit casing (not shown) to allow cover (1) to be hinge-idly coupled to pit cross bar (40) and the pit casing (3).

The removable cross bar (40) is adapted to release-ably engage formations or brackets on the inner walls of the pit casing (not shown).

The two part cover arrangement further includes a second cover (38) that has an L shaped flange (41) at one end and hinge formations (42) at the other end for release-ably engaging corresponding hinge recesses or apertures in the pit casing (not shown) to allow cover (38) to be hinge-idly coupled to the pit casing in an analogous way that cover (1) is hinge-idly coupled to pit casing (3) in the embodiment illustrated in FIGS. 1 and 2.

In use cross bar (40) is located in situ so that it engages the pit casing then one end (43) of cover (38) is hinge-idly coupled to the pit casing in an analogous way that cover (1) is hinge-idly coupled to pit casing (3) in the embodiment illustrated in FIGS. 1 and 2, and the other end (44) of cover (38) is brought to rest on top of cross bar (40) to close off a portion of the service opening of the pit casing (not shown), then cover (1) is hinge-idly coupled to the cross bar (40) as shown in FIG. 13 while engaging the L shaped flange (41), and then cover (1) can be hinge-idly positioned to close off the remaining portion of the service opening of the pit casing (not shown), and when cover (1) is coupled to second member (7) on the pit casing (not shown) both cover (38) and cover (1) can not be moved from the closed position to uncover the service opening of the pit casing (not shown).

Similarly when access to the contents of the pit casing is required when cover (38) and cover (1) are in their respective closed positions and cover the service opening of the pit casing then subject to the degree of access that is required then cover (1) can be moved from its closed position and or removed completely, and then cover (38) additionally may be moved from it's closed position and or removed completely, and cross bar (40) maybe removed from its in-situ position providing the greatest degree of access to the service opening of the pit casing.

The invention has been described by way of example only with reference to preferred embodiments which is not intended to introduce limitations on the scope of the invention. It will be appreciated by persons skilled in the art that alternative embodiments exist even though they may not have been described herein which remain within the scope and spirit of the invention as broadly described herein.

1. A cover for closing the service opening of a pit, the cover includes:
a) an opening with a hatch that has a closed position that hinders access through the opening in the cover;
b) a closed position that hinders access to contents of the pit;
wherein when the hatch and cover are moved to their respective closed positions the hatch and cover are releasably engaged with the pit in their respective closed positions to resist opening of the hatch and or cover from their respective closed positions.

2. A cover in accordance with claim 1 including a first member coupled to the cover that is accessible through the opening in the cover when the hatch is not in a closed position and when the cover is in its closed position the first member can be coupled to the pit to resist the cover from being moved from its closed position.

3. A cover according to claim 1, wherein the hatch is biased in the closed position.

4. A cover according to claim 1, wherein the hatch can be latched in an open position where the opening in the cover is uncovered.

5. A cover according to claim 1, wherein the hatch is pivotally coupled to the cover.

6. A cover according to claim 1, wherein a second member releasably engages the hatch when the cover and hatch are in their respective closed positions and while the second member is in engagement with the hatch it resists opening of the cover and hatch from their respective closed positions.

7. A cover according to claim 6, wherein the first member includes a cooperative opening through which the threaded portion of a bolt can extend and threadingly engage a cooperative threaded aperture portion on the second member to couple the first and second member together, wherein the head of the bolt can be operationally accessed through the opening in the cover when the hatch is not in the closed position and when the bolt is operationally tightened to firmly couple the first and second members together it resists opening of the cover from its closed position.

8. A cover according to claim 6, wherein the first member includes an opening through which a staple portion of the second member can extend when the cover is in the closed position, the staple portion including a hole formation that can receive the shank of a padlock, and when the cover is in the closed position and the shank of the padlock is received by the hole formation the padlock releasably and lockingly can couple the first and second members together, wherein the padlock can be operationally accessed through the opening in the cover when the hatch is not in the closed position and locked or removed as required through the opening.

9. A cover according to claim 2, wherein the first member includes an enclosure portion, the inside of the enclosure portion being in communication with the opening in the cover.

10. A cover according to claim 6, wherein the second member is formed separately from and fixed to the pit.

11. A cover according to claim 1, wherein the cover is releasably hingidly coupled to the pit.

12. A cover according to claim 1, wherein the cover and pit include cooperative hinge formations and corresponding hinge recesses or apertures arrangements and combinations to allow the cover to be releasably hingidly coupled to the pit.

13. A cover according to claim 1, wherein the pit includes a cover casing having two opposed openings wherein both opposed openings are in communication with the service opening of the pit and when the cover is in the closed position the two opposed openings are closed by the cover.

14. A cover according to claim 1, wherein the pit may include a casing and/or collar and/or frame to receive the cover when it is in its closed position.

15. (canceled)
